(19) United States
(12) Patent Application Publication
(10) Pub. No.: US 2009/0033222 A1
(43) Pub. Date: Feb. 5, 2009

(54) PLASMA DISPLAY DEVICE

(76) Inventors: Yu Park, Kyungsangbuk-do (KR); Tae Deok Seo, Kyungsangbuk-do (KR); Hun Gun Park, Kyungsangbuk-do (KR)

Correspondence Address: KED & ASSOCIATES, LLP, P.O. Box 221200, Chantilly, VA, 20153-1200, US

(21) Appl. No.: 12/162,299

(22) PCT Filed: Sep. 28, 2006
(86) PCT No.: PCT/KR06/03906

§ 371 Date: Oct. 7, 2008

(30) Foreign Application Priority Data
Jul. 19, 2006 (KR) 10-2006-0067527
Sep. 25, 2006 (KR) 10-2006-0093118

(51) Int. Cl. H01J 17/49; G02B 5/28

(52) U.S. Cl. 313/582; 359/590

(57) ABSTRACT

In a plasma display apparatus of the preset invention, an external light shielding sheet configured to shield externally incident light to the greatest extent possible is disposed at the front, thus effectively implementing a black image and improving the bright and dark room contrast. Furthermore, pattern units of the external light shielding sheet are formed using a conductivity material. Accordingly, there is an advantage in that EMI emitted from a panel can be prevented from being radiated to the outside.

### TECHNICAL FIELD

The present invention relates, in general, to a plasma display apparatus, and more particularly, to a plasma display apparatus in which an external light shielding sheet is disposed at the front in order to shield external light incident from the outside of a panel, thereby improving the bright and dark room contrast of the panel and sustaining the luminance of the panel.

### BACKGROUND ART

In general, a Plasma Display Panel (hereinafter, referred to as a “PDP”) is an apparatus configured to generate a discharge by applying voltage to electrodes disposed in discharge spaces and to display an image including characters and/or graphics by exciting phosphors with plasma generated during the discharge of gas. The PDP is advantageous in that it can be made large, light and thin, can provide a wide viewing angle in all directions, and can implement full colors and high luminance.

In the PDP constructed above, when a black image is implemented, external light is reflected from the front of the panel due to white-based phosphor exposed to the lower plate of the panel. Therefore, a problem arises because a black image is recognized as a bright-based dark color, resulting in a lowered contract.

### DISCLOSURE

### Technical Problem

The present invention has been developed in an effort to provide a plasma display apparatus having the advantages of preventing the reflection of light by effectively shielding external light incident on a panel, and improving the bright and dark room contrast and luminance of the panel.

The present invention has also been developed in an effort to provide an external light shielding sheet, which can replace an EMI shield layer.

### Technical Solution

To accomplish the above objects, a plasma display apparatus according to an embodiment of the present invention includes a PDP, and a filter disposed at the front of the PDP. The filter includes a transparent substrate, a base unit and pattern units, both of which are formed on the transparent substrate, wherein a black oxidization process is performed on the pattern units, an AR layer formed to a thickness of 90 to 120 μm, and a NIR shielding sheet formed to a thickness of 100 to 120 μm. A width at ½ of a height of each of the pattern units is set in the range of 6 to 23 μm, a bottom width of the pattern unit is set in the range of 18 to 35 μM, and the pattern units are formed using a material containing carbon.

The NIR shielding layer includes an acryl-based adhesive. The acryl-based adhesive is a copolymer in which one of (metha)crylic acid monomer 75 to 99.89 weight % having an alkyl group of carbon number 1 to 12, unsaturated carboxylic acid monomers 0.1 to 20 weight %, which is functional monomers, and a comprehensive monomer 0.01 to 5 weight % having a hydroxyl group, is mixed of a combination of them are mixed. In this case, the functions of the NIR shielding layer can be protected, transparency enabling light to be transmitted smoothly, can be secured, and the base sheet 213 can be easily attached to the other sheet and the front of the panel.

The pattern units may be formed using a metal material, such as silver, iron, nickel, chrome, copper, aluminum, titanium or lead. The metal material may have a resistance of 0.001 to 2.5. The pattern units may include oxide compounds, such as copper oxide, copper dioxide and oxidized steel.

It is preferred that a refractive index of the pattern unit be 0.300 to 0.999 times greater than that of the base unit. A thickness of the NIR shielding sheet may be 1.01 to 2.25 times greater than the height of the pattern unit. The shortest distance between neighboring pattern units may be 1.1 to 5 times greater than the bottom width of the pattern unit. The height of the pattern unit may be 0.89 to 4.25 times greater than the shortest distance between neighboring pattern units. A distance between tops of neighboring pattern units may be 1 to 3.25 times greater than a distance between bottoms of neighboring pattern units.

A filter for a plasma display apparatus includes a transparent substrate, a base unit and pattern units, both of which are formed on the transparent substrate, wherein a black oxidization process is performed on the pattern units, an AR layer formed to a thickness of 90 to 120 μm, and a NIR shielding sheet formed to a thickness of 100 to 120 μm. A width at ½ of a height of each of the pattern units is set in the range of 6 to 23 μm, a bottom width of the pattern unit is set in the range of 18 to 35 μm, and the pattern units are formed using a material containing carbon.

### ADVANTAGEOUS EFFECTS

The plasma display apparatus according to the present invention includes an external light-shielding sheet configured to shield externally incident light to the greatest extent possible and disposed at the front of a panel. It is therefore possible to effectively implement a black image and improve the bright and dark room contrast.

Furthermore, each of pattern units of the external light shielding sheet is formed from a conductive material, and it is thus advantageous in that it can prevent EMI, which is generated from the panel, from being radiated to the outside.

### DESCRIPTION OF DRAWINGS

FIG. 1 is a perspective view illustrating an embodiment of the construction of a PDP according to an embodiment of the present invention.

FIG. 2 is a view illustrating an embodiment of electrode arrangements of the PDP.

FIG. 3 is a timing diagram showing an embodiment of a method of driving a plasma display apparatus with one frame of an image being time-divided into a plurality of subfields.

FIG. 4 is a timing diagram illustrating waveforms for driving the plasma display apparatus according to the present invention.

FIGS. 5 to 9 are cross-sectional views illustrating embodiments of an external light shielding sheet according to the present invention.

FIG. 10 is a cross-sectional view of the external light shielding sheet for illustrating the relationship between the thickness of the external light shielding sheet and the height of a pattern unit.

FIGS. 11 and 12 are cross-sectional views illustrating the structure of the external light shielding sheet according to an embodiment of the present invention.

FIGS. 13 and 14 are cross-sectional views illustrating embodiments of the construction of a filter to which the external light shielding sheet of the present invention is applied.

### BEST MODE

A plasma display apparatus according to the present invention will now be described in detail in connection with specific embodiments with reference to the accompanying drawings.

It is to be understood that the plasma display apparatus of the present invention is not limited to the embodiments, but may include a variety of embodiments.

The embodiments of the present invention will be described below with reference to the accompanying drawings.

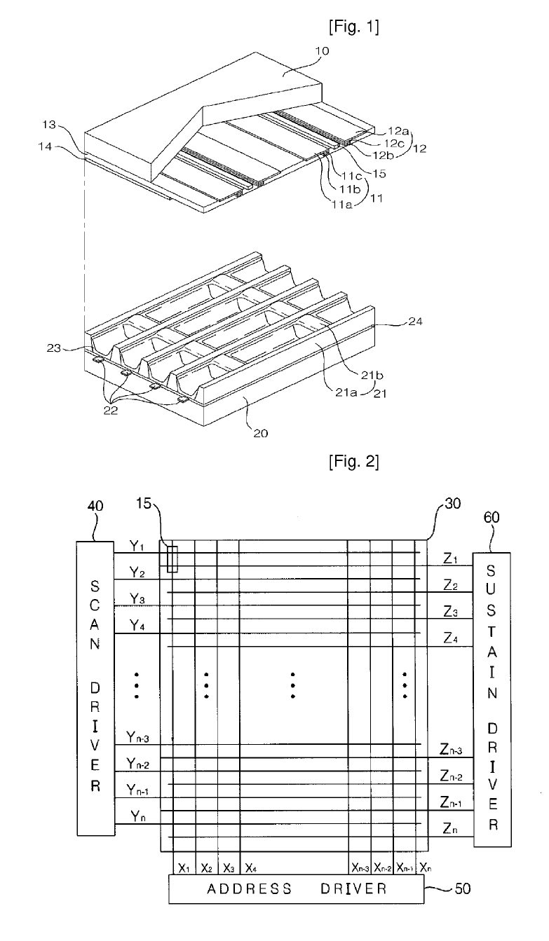

FIG. 1 is a perspective view illustrating an embodiment of the construction of a PDP according to an embodiment of the present invention.

Referring to FIG. 1, the PDP includes a scan electrode 11 and a sustain electrode 12 (i.e., a sustain electrode pair) both of which are formed on a front substrate 10, and address electrodes 22 formed on a rear substrate 20.

The sustain electrode pair 11 and 12 includes transparent electrodes 11a and 12a, and bus electrodes 11b and 12b. The transparent electrodes 11a and 12a are generally formed of Indium-Tin-Oxide (ITO). The bus electrodes 11b and 12b may be formed using metal, such as silver (Ag) or chrome (Cr), a stack of Cr/copper (Cu)/Cr, or a stack of Cr/aluminum (Al)/Cr. The bus electrodes 11b and 12b are formed on the transparent electrodes 11a and 12a and serve to reduce a voltage drop caused by the transparent electrodes 11a and 12a having a high resistance.

Meanwhile, according to an embodiment of the present invention, the sustain electrode pair 11 and 12 may have a structure in which the transparent electrodes 11a and 12a and the bus electrodes 11b and 12b are laminated, or include only the bus electrodes 11b and 12b without the transparent electrodes 11a and 12a. Such a structure is advantageous in that it can save the manufacturing cost of the panel because it does not require the transparent electrodes 11a and 12a. The bus electrodes 11b and 12b used in the structure may also be formed using a variety of materials, such as a photosensitive material, other than the above-mentioned materials.

Black matrices (BM) 15 are arranged between the transparent electrodes 11a and 12a and the bus electrodes 11b and 12b of the scan electrode 11 and the sustain electrode 12. The black matrices 15 has a light-shielding function of reducing the reflection of external light generated outside the front substrate 10 by absorbing the external light and a function of improving the purity and contrast of the front substrate 10.

The black matrices 15 according to an embodiment of the present invention are formed in the front substrate 10. Each of the black matrices 15 may include a first black matrix 15 formed at a location at which it is overlapped with a barrier rib 21, and second black matrices 11c and 12c formed between the transparent electrodes 11a and 12a and the bus electrodes 11b and 12b. The first black matrix 15, and the second black matrices 11c and 12c, which are also referred to as a “black layer” or a “black electrode layer”, may be formed at the same time and be connected physically, or may be formed separately and not be connected physically.

In the case where the first black matrix 15 and the second black matrices 11c and 12c are connected to each other physically, the first black matrix 15 and the second black matrices 11c and 12c may be formed using the same material. However, in the event that the first black matrix 15 and the second black matrices 11c and 12c are not connected to each other physically, the first black matrix 15 and the second black matrices 11c and 12c may be formed using different materials.

An upper dielectric layer 13 and a protection layer 14 are laminated on the front substrate 10 in which the scan electrodes 11 and the sustain electrodes 12 are formed in parallel. Charged particles generated by a discharge are accumulated on the upper dielectric layer 13. The upper dielectric layer 13 can serve to protect the sustain electrode pair 11 and 12. The protection layer 14 serves to protect the upper dielectric layer 13 from sputtering of charged particles generated during the discharge of a gas and also to increase emission efficiency of secondary electrons.

The address electrodes 22 are formed in such a way to cross the scan electrodes 11 and the sustain electrodes 12. Lower dielectric layers 24 and barrier ribs 21 are also formed on the rear substrate 20 in which the address electrodes 22 are formed.

A phosphor layer 23 is formed on the lower dielectric layers 24 and the surfaces of the barrier ribs 21. Each of the barrier ribs 21 includes a longitudinal barrier rib 21a and a traverse barrier rib 21b, both of which form a closed fashion. The barrier ribs 21 can separate discharge cells physically, and can also prevent ultraviolet rays generated by a discharge and a visible ray from leaking to neighboring discharge cells.

Referring to FIG. 1, it is preferred that a filter 100 be formed at the front of the PDP according to the present invention. The filter 100 may include an external light shielding sheet, an Anti-Reflection (AR) sheet, a Near Infrared (NIR) shielding sheet, an Electromagnetic Interference (EMI) shielding sheet, a diffusion sheet, an optical characteristic sheet, and so on.

An adhesive layer or a cohesive layer may be formed between the filter 100 and the panel. When the adhesive layer or the cohesive layer has a thickness of 10 to 30 μm, it can effectively block externally incident light and can also effectively radiate light, generated from the panel, to the outside.

In order to protect the panel from external pressure, etc., the thickness of the adhesive layer or the cohesive layer may be set in the range of 30 to 120 μm. In order to prevent the panel from shock, a film having a function of absorbing shock may also be formed between the filter 100 and the panel.

An embodiment of the present invention may include not only the structure of the barrier ribs 21 illustrated in FIG. 1, but also the structure of barrier ribs having a variety of shapes. For example, an embodiment of the present invention may include a differential type barrier rib structure in which the longitudinal barrier rib 21a and the traverse barrier rib 21b have different height, a channel type barrier rib structure in which a channel that can be used as an exhaust passage is formed in at least one of the longitudinal barrier rib 21a and the traverse barrier rib 21b, a hollow type barrier rib structure in which a hollow is formed in at least one of the longitudinal barrier rib 21a and the traverse barrier rib 21b.

In the differential type barrier rib structure, it is preferred that the traverse barrier rib 21b have a height higher than that of the longitudinal barrier rib 21a. In the channel type barrier rib structure or the hollow type barrier rib structure, it is preferred that a channel or a hollow be formed in the traverse barrier rib 21b.

Meanwhile, in the present embodiment, it has been described that the red (R), green (G), and blue (B) discharge cells are arranged on the same line. However, the R, G, and B discharge cells may be arranged in different forms. For example, the R, G, and B discharge cells may have a delta type arrangement in which they are arranged in a triangle. Furthermore, the discharge cells may be arranged in a variety of forms, such as square, pentagon and hexagon.

The phosphor layer is emitted with ultraviolet rays generated during the discharge of a gas to generate any one visible ray of red, green and blue. Discharge spaces provided between the upper/rear substrates 10 and 20 and the barrier ribs 21 are injected with a mixed inert gas, such as He+Xe, Ne+Xe or He+Ne+Xe.

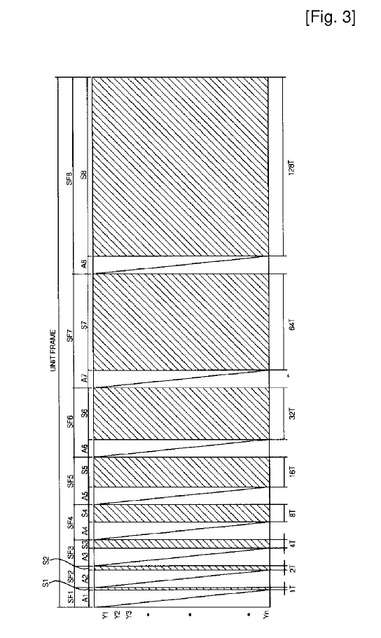

FIG. 2 is a view illustrating an embodiment of electrode arrangements of the PDP. It is preferred that a plurality of discharge cells constituting the PDP be arranged in matrix form, as illustrated in FIG. 2. The plurality of discharge cells are respectively disposed at the intersections of scan electrode lines Y1 to Ym, sustain electrodes lines Z1 to Zm, and address electrodes lines X1 to Xn. The scan electrode lines Y1 to Ym may be driven sequentially or simultaneously. The sustain electrode lines Z1 to Zm may be driven at the same time. The address electrode lines X1 to Xn may be driven with them being divided into even-numbered lines and odd-numbered lines, or may be driven sequentially.

The electrode arrangement shown in FIG. 2 is only an embodiment of the electrode arrangements of the PDP according to an embodiment of the present invention. Thus, the present invention is not limited to the electrode arrangements and the driving method of the PDP, as illustrated in FIG. 2. For example, the present invention may be applied to a dual scan method in which two of the scan electrode lines Y1 to Ym are driven at the same time. Furthermore, the address electrode lines X1 to Xn may be driven with them being divided into upper and lower parts on the basis of the center of the panel.

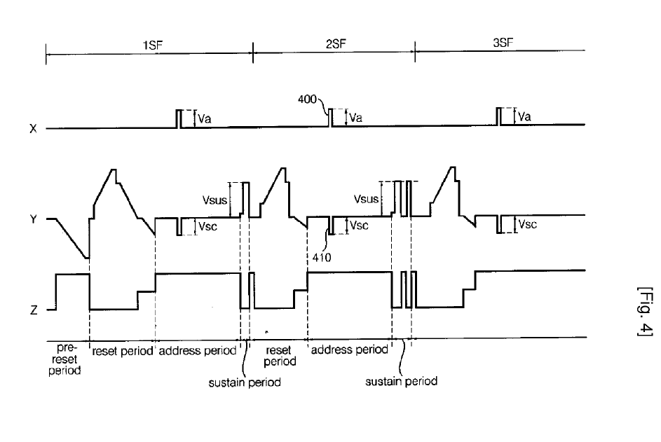

FIG. 3 is a timing diagram illustrating an embodiment of a method of driving the plasma display apparatus with one frame of an image being time-divided into a plurality of subfields. A unit frame may be divided into a predetermined number (for example, eight subfields SF1, . . . , SF8) in order to realize time-divided gray level display. Each of the subfields SF1, . . . , SF8 is divided into a reset period (not shown), address periods A1, . . . , A8, and sustain periods S1, . . . , S8.

According to the present invention, the reset period may be omitted from at least one of the plurality of subfields. For example, the reset period may exist only in the first subfield, or may exist only in a subfield approximately between the first subfield and the whole subfields.

In each of the address periods A1, . . . , A8, an address signal is applied to address electrodes X, and scan signals corresponding to the respective scan electrodes Y are sequentially applied to the address electrodes X.

In each of the sustain periods S1, . . . , S8, a sustain signal is alternately applied to the scan electrodes Y and a sustain electrodes Z. Accordingly, a sustain discharge is generated in discharge cells on which wall charges are formed in the address periods A1, . . . , A8.

The luminance of the PDP is proportional to the number of sustain discharge pulses within the sustain periods S1, . . . , S8 occupied in the unit frame. In the case where one frame forming 1 image is represented by eight subfields and 256 gray levels, a different number of sustain signals may be sequentially allocated to the respective subfields in the ratio of 1, 2, 4, 8, 16, 32, 64, and 128. For example, to obtain the luminance of 133 gray levels, a sustain discharge can be generated by addressing cells during the subfield1 period, the subfield3 period, and the subfield8 period.

The number of sustain discharges allocated to each subfield may be varied depending on the weights of subfields based on an Automatic Power Control (APC) step. That is, a case where one frame is time-divided into eight subfields has been described with reference to FIG. 3. However, the present invention is not limited to the above example, but the number of subfields forming one frame may be varied depending on design specifications. For example, the PDP can be driven by dividing one frame into eight or more subfields, such as 12 or 16 subfields.

Furthermore, the number of sustain discharges, allocated to each subfield, may be changed in various ways by taking a gamma characteristic or a panel characteristic into consideration. For example, the degree of a gray level allocated to the subfield4 can be lowered from 8 to 6, and the degree of a gray level allocated to the subfield6 can be lowered from 32 to 34.

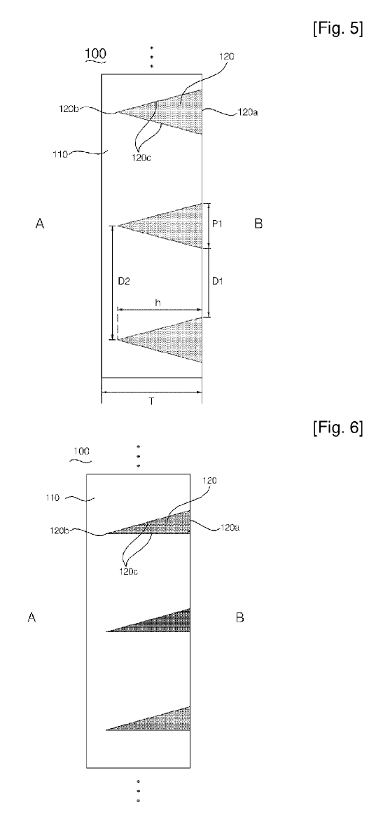

FIG. 4 is a timing diagram illustrating an embodiment of driving signals for driving the PDP with respect to one of the divided subfield.

Each subfield includes a pre-reset period for forming positive wall charges on the scan electrodes Y and negative wall charges on the sustain electrodes Z, a reset period for initializing discharge cells of the whole screen by employing wall charge distributions formed by means of the pre-reset period, an address period for selecting discharge cells, and a sustain period for sustaining the discharge of selected discharge cells.

The reset period includes a set-up period and a set-down period. In the set-up period, a ramp-up waveform Ramp-up is applied to the entire scan electrodes at the same time. Thus, a minute discharge is generated in the entire discharge cells and wall charges are generated accordingly. In the set-down period, a ramp-down waveform Ramp-down, which falls from a positive voltage lower than a peak voltage of the ramp-up waveform, is applied to the entire scan electrodes Y at the same time. Accordingly, an erase discharge is generated in the entire discharge cells, thereby erasing unnecessary charges from the wall charges generated by the set-up discharge and spatial charges.

In the address period, a scan signal 410 having a negative scan voltage Vsc is sequentially applied to the scan electrodes, and an address signal 400 having a positive address voltage Va is applied to the address electrodes so that it is overlapped with the scan signal. Therefore, an address discharge is generated due to a voltage difference between the scan signal 410 and the address signal 400 and a wall voltage generated during the reset period, so that cells are selected. Meanwhile, during the set-down period and the address period, a signal to sustain a sustain voltage is applied to the sustain electrodes.

In the sustain period, a sustain signal is alternately applied to the scan electrodes and the sustain electrodes, thus generating a sustain discharge between the scan electrodes and the sustain electrodes in a surface discharge fashion.

The driving waveforms illustrated in FIG. 4 correspond a first embodiment of signals for driving the PDP according to the present invention. However, the present invention is not limited to the waveforms illustrated in FIG. 4. For example, the pre-reset period may be omitted, the polarities and voltage levels of the driving signals illustrated in FIG. 4 may be changed, if needed, and an erase signal for erasing wall charges may be applied to the sustain electrodes after the sustain discharge is completed. The present invention may also be applied to a single sustain driving method in which the sustain signal is applied to either the scan electrodes Y or the sustain electrodes Z, thus generating a sustain discharge.

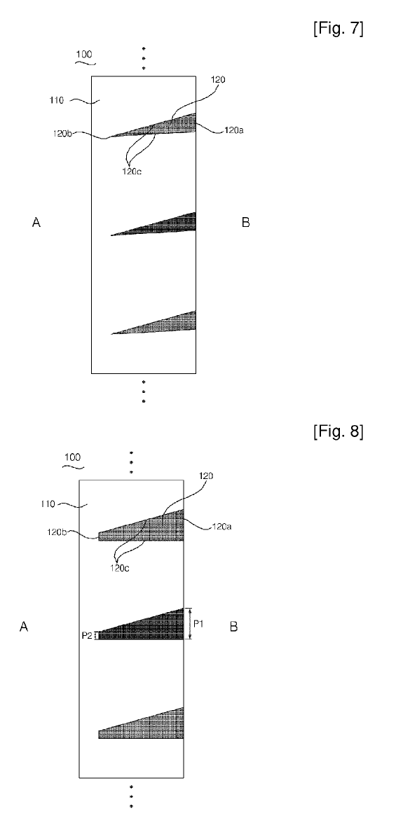

FIGS. 5 to 9 are cross-sectional views illustrating embodiments of pattern units of the external light shielding sheet according to the present invention. As illustrated in FIG. 5, the external light shielding sheet 100 includes a base unit 110 and pattern units 120.

When the external light shielding sheet 100 has a thickness T of 20 to 250 μm, the manufacturing process is convenient and an adequate optical transmittance can be secured. The thickness T of the external light shielding sheet 100 may be set in the range of 100 to 180 μm so that light emitted from the panel smoothly transmits through the external light shielding sheet, externally incident light is refracted from and effectively absorbed and blocked by the pattern units 120, and the robustness of the sheet can be obtained.

Referring to FIG. 5, the pattern units 120 formed on the base unit 110 may have a triangle, more preferably, an isosceles triangle. The pattern units 120 is formed of a dark-based material compared with the base unit 110. For example, the pattern units 120 may be formed using a carbon-based material, or the outer circumference of the pattern unit 120 may be coated with dark dyes. Accordingly, an effect of absorbing external light can be enhanced by the outer circumference of the pattern unit 120.

It is preferred that a bottom 120a of the pattern unit included in the external light shielding sheet 100 be disposed on a panel side B, and a top 120b of the pattern unit included in the external light shielding sheet 100 be disposed on a viewer side A to which external light is incident. An external light source is generally located over the panel and, therefore, the external light will be incident on the panel with inclination from the upper side of the panel.

In order to absorb and shield the external light and totally reflect a visible ray emitted from the panel, thus increasing the reflectance of the panel light, it is preferred that the refractive index of the pattern unit 120 (that is, the refractive index of the inclined surface (that is, at least a part of the pattern unit 120) be lower than that of the base unit 110. In order to maximize the absorption of external light and the total reflection of panel light considering the angle of the external light incident on the panel, it is preferred that the reflective index of the pattern unit 120 be 0.300 to 0.999 times greater than that of the base unit 110.

Furthermore, the pattern unit 120 may have a bottom width P1 of 18 to 35 μm. In this case, the aperture ratio for allowing light, generated from the panel, to be smoothly radiated to the viewer side A can be obtained, and the external light shielding efficiency can be maximized.

The pattern units 120 may have a height “h” of 80 to 170 μm. It is therefore possible to form an inclined surface gradient, which allows the external light to be effectively absorbed and the panel light to be effectively reflected in the relationship with the bottom width P1, and also to prevent the short of the pattern units 120. In this case, the height of the pattern unit 120 refers to the longest length from the bottom 120a of the pattern unit to the top 120b of the pattern unit 120.

In order to secure the aperture ratio for displaying a display image with an adequate luminance as the panel light is radiated to the viewer side A, and an optimal tilt of the inclined surface 120c of the pattern unit 120 for improving the external light shielding effect and the panel light reflection efficiency, a distance D1 between two neighboring pattern units may be set in the range of 40 to 90 μm, and a distance D2 between tops of two neighboring pattern units may range from 60 to 130 μm. The distance D1 between two neighboring pattern units refers to the shortest distance between two neighboring pattern units 120, and is substantially the same as the shortest distance between bottoms of two neighboring pattern units.

For the above reasons, when the distance D1 between two neighboring pattern units is 1.1 to 5 times greater than the bottom width of the pattern unit 120, the aperture ratio for display can be secured, and the external light shielding effect and the panel light reflection efficiency can be enhanced.

When the height “h” of the pattern unit 120 is 0.89 to 4.25 times greater than the distance D1 between two neighboring pattern units, external light incident from the upper side of the panel with inclination can be prevented from being incident on the panel, the short of the pattern units 120 can be prevented, and the reflectance of the panel light can be optimized.

When the distance D2 between tops of two neighboring pattern units is 1 to 3.25 times greater than the distance D1 between bottoms of two neighboring pattern units, the aperture ratio for displaying an image having an adequate luminance can be secured, and the panel light can be totally reflected from the inclined surface 120c of the pattern unit.

Referring to FIGS. 6 to 7, the pattern units 120 may be formed asymmetrically right and left. That is, the right and left inclined surface areas of each of the pattern units 120 may be different from each other, or an angle formed by the right inclined surface of the pattern unit 120 and the bottom of the pattern unit 12 may be different from an angle formed by the inclined surface of the pattern unit 120 and the bottom of the pattern unit 12.

In general, since objects generating external light are located over the panel, the external light is incident on the panel from the upper side of the panel within a given angle range. Accordingly, in order to increase the external light absorption effect and the reflectance of light emitted from the panel, the gradient of an upper-side inclined surface on which the external light is incident, of two inclined surfaces of the pattern unit 120, may be slower than that of a lower-side inclined surface of the two inclined surfaces of the pattern unit 120. In other words, the gradient of the upper-side inclined surface of the two inclined surfaces of the pattern unit 120 may be set lower than that of the lower-side inclined surface of the two inclined surfaces of the pattern unit 120.

Referring to FIG. 8, each of the pattern units 120 may have a trapezoid. In this case, the top width P2 is set smaller than the bottom width P1. The top width P2 of the pattern unit 120 may be set in the range of 5 μm or less. Accordingly, the inclined surface gradient, which effectively enables the absorption of external light and the reflection of panel light, can be formed in the relationship with the bottom width P1.

As illustrated in FIG. 9, in the pattern units illustrated in FIGS. 6 and 7, the right and left inclined surfaces may have a curved shape. The top or bottom of the pattern unit may have a curved shape.

In the embodiments of the sectional shapes of the pattern units illustrated in FIGS. 5 to 9, the edge portions of the pattern units may have a curved shape having a specific curvature. The edge portions of the bottoms of the pattern units may have a curved shape extending externally.

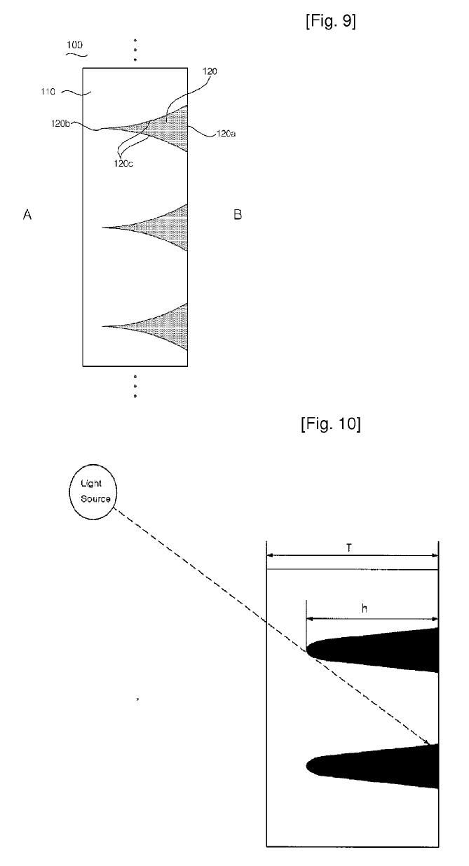

FIG. 10 is a cross-sectional view illustrating an embodiment of the structure of the external light shielding sheet according to the present invention in order to describe the thickness of the external light shielding sheet and the height of the pattern unit.

Referring to FIG. 10, in order to secure the roughness of the external light shielding sheet including the pattern units and also to secure the transmittance of a visible ray emitted from the panel so as to display an image, it is preferred that the external light shielding sheet have a thickness T of 100 μl to 180 μm.

When the height “h” of each of the pattern units included in the external light shielding sheet is 80 to 170 μm, the fabrication of the pattern units is the most convenient, the external light shielding sheet can have an adequate aperture ratio, and the external light shielding effect and the effect of reflecting light emitted from the panel can be maximized.

The height “h” of the pattern unit may be varied depending on the thickness T of the external light shielding sheet. In general, external light, being incident on the panel to affect lowering in the bright and dark room contrast, is mainly located at a location higher than the panel. Thus, in order to effectively shield external light incident on the panel, it is preferred that the height “h” of the pattern unit have a specific value range with respect to the thickness T of the external light shielding sheet.

As the height “h” of the pattern unit increases as illustrated in FIG. 10, the thickness of the base unit at the top of the pattern unit becomes thin, resulting in insulating breakdown or short. As the height “h” of the pattern unit decreases, external light having an angle range is incident on the panel, thereby hindering the shielding of the external light.

The following Table 1 is an experimental result on insulating breakdown and the external light shielding effect of the external light shielding sheet depending on the thickness T of the external light shielding sheet and the height “h” of the pattern unit.

TABLE 1

| Thicknes (T) | Height (h) of | | Insulating | External Light |
|---|---|---|---|---|
| of Sheet | Pattern Unit | | Breakdown | Shielding Effect |
| 120 μm | 120 | μm | ◯ | ◯ |
| 120 μm | 115 | μm | Δ | ◯ |
| 120 μm | 110 | μm | X | ◯ |
| 120 μm | 105 | μm | X | ◯ |
| 120 μm | 100 | μm | X | ◯ |
| 120 μm | 95 | μm | X | ◯ |
| 120 μm | 90 | μm | X | ◯ |
| 120 μm | 85 | μm | X | ◯ |
| 120 μm | 80 | μm | X | ◯ |
| 120 μm | 75 | μm | X | Δ |
| 120 μm | 70 | μm | X | Δ |
| 120 μm | 65 | μm | X | Δ |
| 120 μm | 60 | μm | X | Δ |
| 120 μm | 55 | μm | X | Δ |
| 120 μm | 50 | μm | X | X |

Referring to Table 1, when the thickness T of the external light shielding sheet is 120 μm, if the height “h” of the pattern unit is set to 120 μm or more, the failure rate of a product may increase since there is a danger that the pattern unit may experience insulating breakdown. If the height “h” of the pattern unit is set to 110 μm or less, the failure rate of the external light shielding sheet may decrease since there is no danger that the pattern unit may experience insulating breakdown. However, when the height of the pattern unit is set to 75 μm or less, an efficiency in which external light is shielded by the pattern units may decrease. When the height of the pattern unit is set to 50 μm or less, external light can be incident on the panel.

When the thickness T of the external light shielding sheet is 1.01 to 2.25 times greater than the height “h” of the pattern unit, insulating breakdown at the top portion of the pattern unit can be prevented, and external light can be prevented from being incident on the panel. In order to increase the amount of reflection of light emitted from the panel and to secure a viewing angle while preventing insulating breakdown and external light from being incident on the panel, the thickness T of the external light shielding sheet may be 1.01 to 1.5 times greater than the height “h” of the pattern unit.

The PDP may have a Moire phenomenon due to its lattice structure. The Moire phenomenon refers to patterns of a low frequency, which occur as patterns having a similar lattice shape are overlapped. For example, the Moire phenomenon may refer to wave patterns appearing when mosquito nets are overlapped.

The following Table 2 is an experimental result on whether the Moire phenomenon has occurred, and the external light shielding effect, depending on the ratio of the bottom width P1 of the pattern unit of the external light shielding sheet and the width of the bus electrode formed in the front substrate of the panel. In this case, the width of the bus electrode was 90 μm.

TABLE 2

| Bottom Width of Pattern Unit/Width | Moire | External Light |
|---|---|---|
| of Bus Electrode | Phenomenon | Shielding Effect |
| 0.10 | Δ | X |
| 0.15 | Δ | X |
| 0.20 | X | Δ |
| 0.25 | X | ◯ |
| 0.30 | X | ◯ |
| 0.35 | X | ◯ |
| 0.40 | X | ◯ |
| 0.45 | Δ | ◯ |
| 0.50 | Δ | ◯ |
| 0.55 | ◯ | ◯ |
| 0.60 | ◯ | ◯ |

From Table 2, it can be seen that the bottom width P1 of the pattern unit is 0.2 to 0.5 times greater than the width of the bus electrode, the Moire phenomenon can be reduced, and external light incident on the panel can be decreased. In order to prevent the Moire phenomenon and effectively shield external light while securing the aperture ratio for radiating the panel light, it is preferred that the bottom width P1 of the pattern unit be 0.25 to 0.4 times greater than the width of the bus electrode.

The following Table 3 is an experimental result on whether the Moire phenomenon has occurred and the external light shielding effect depending on the ratio of the bottom width P1 of the pattern unit of the external light shielding sheet and the width of the longitudinal barrier rib formed in the rear substrate of the panel. The width of the longitudinal barrier rib was set to 50 μm.

TABLE 3

| Bottom Width of Pattern Unit/Top | Moire | External Light |
|---|---|---|
| Width of Longitudinal Barrier Rib | Phenomenon | Shielding Effect |
| 0.10 | ◯ | X |
| 0.15 | Δ | X |
| 0.20 | Δ | X |
| 0.25 | Δ | X |
| 0.30 | X | Δ |
| 0.35 | X | Δ |
| 0.40 | X | ◯ |
| 0.45 | X | ◯ |
| 0.50 | X | ◯ |
| 0.55 | X | ◯ |
| 0.60 | X | ◯ |
| 0.65 | X | ◯ |
| 0.70 | Δ | ◯ |
| 0.75 | Δ | ◯ |
| 0.80 | Δ | ◯ |
| 0.85 | ◯ | ◯ |
| 0.90 | ◯ | ◯ |

From Table 3, it can be seen that when the bottom width P1 of the pattern unit is 0.3 to 0.8 times greater than the width of the longitudinal barrier rib, the Moire phenomenon can be reduced and external light incident on the panel can be decreased. In order to prevent the Moire phenomenon and also effectively shield external light while securing the aperture ratio for discharging the panel light, it is preferred that the bottom width P1 of the pattern unit be 0.4 to 0.65 times greater than the width of the longitudinal barrier rib.

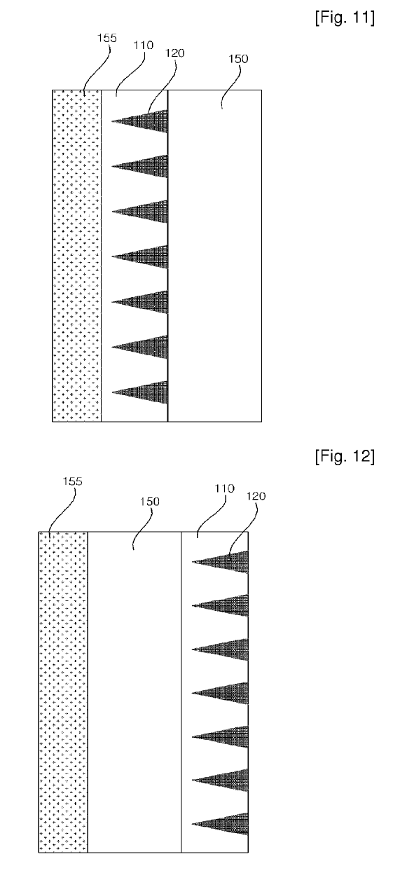

FIGS. 11 and 12 are cross-sectional views illustrating the structure of the external light shielding sheet according to an embodiment of the present invention.

Referring to FIGS. 11 and 12, the filter of the present invention includes a transparent substrate 150 and the external light shielding sheet. The transparent substrate 150 may be formed of glass, polyester resin, cellulose resin, styrene resin, acryl-based resin or the like, which have a good mechanical strength, preferably, glass or acrylic resin made of a polymethylmethacrylate-based synthesizer. In this case, an average ray transmittance of 50%, which is 450 to 650 nm in wavelength, can be secured, making the transparent substrate 150 more transparent with respect to a visible ray.

The thickness of the transparent substrate 150 is not specially limited, but is preferably in the range of 1 to 10 mm in consideration of mechanical strength and a high cost due to excessive weight. The transparent substrate 150 is formed using ITO having a low electrical resistance component. When the pattern units 120 of the external light shielding sheet is formed of metal with conductivity, the ground force of the pattern units 120 can be supplemented.

A black oxidization process is performed on at least one side of the outer circumference of the pattern unit 120 so that it has a color darker than the base unit. In this case, when external light, such as sunlight or electrical light, is incident on the panel, the portion on which the black oxidization process has been performed can prohibit and absorb reflection of the light, thus improving a display image of the PDP with a high contrast.

The black oxidization process may include a plating method. In this case, all surfaces of the pattern unit 120 can be easily blackened since the plating method has excellent adherence force. The plating materials may include one or more compounds selected from copper, cobalt, nickel, zinc, tin and chrome, for example, oxide compounds such as copper oxide, copper dioxide and oxidized steel.

If the black oxidization process is performed on the outer circumference of the pattern units 120, the interior surface of the pattern units 120 may be formed using metal material, such as gold, silver, iron, nickel, chrome, copper, aluminum, titanium or lead. In this case, the EMI shielding effect can be increased due to the metal material having a resistance value of 0.001 to 2.5Ω. The lamination sequence of the filter may differ according to a person having ordinary skill in the art, and a sheet 155 having functions, such as anti-reflection, color correction, and NIR shielding, etc. may be laminated on the transparent substrate 150 or the external light shielding sheet.

In order to improve the conductivity and ground force of the external light shielding sheet 100, a layer having one surface made of a transparent conductive material may be formed between the front or rear surface of the filter 100 or the external light shielding sheet 100, and the transparent substrate. For example, the layer may be formed by laminating sheets made of ITO (that is, a transparent conductive material).

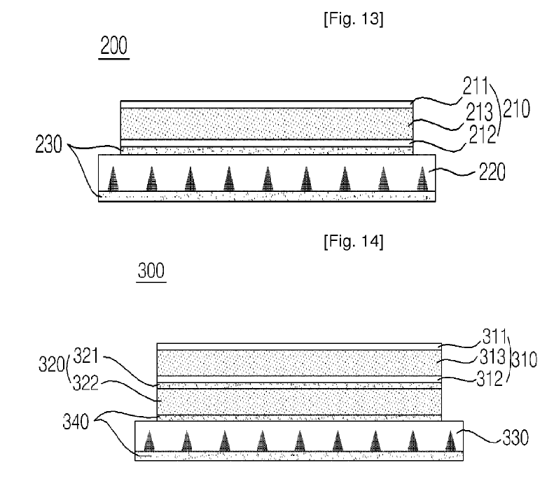

FIGS. 13 and 14 are cross-sectional views illustrating embodiments of the construction of the filter to which the external light shielding sheet of the present invention is applied. The filter formed at the front of the PDP may include an AR/NIR sheet, an external light shielding sheet, an optical characteristic sheet and so on. In FIGS. 13 and 14, the transparent substrate formed on one side of the external light shielding sheet is omitted.

Referring to FIG. 13, an AIR/NIR sheet 210 includes an AR layer 211 disposed on a front surface of a base sheet 213 made of a transparent plastic material, and a NIR shielding layer 212 disposed on a rear surface of the base sheet 213. The AR layer 211 serves to prevent externally incident light from reflecting, thus reducing a glairing phenomenon. The NIR shielding layer 212 serves to shield NIR radiated from the panel, so that signals transferred using infrared rays, such as a remote controller, can be transferred normally.

The base sheet 213 is a thin film, and may be formed using a variety of materials by taking transparency, an insulating property, a heat-resistant property, mechanical strength, etc. into consideration. For example, the materials of the base sheet 213 may include polyester-based resin, polyamid-based resin, polyolefin-based resin, vinyl-based resin, acryl-based resin, cellulose-based resin, and so on. It is preferred that the base sheet 213 be formed using a polyester-based material, such as polyethylene tereophthalate (PET) and polyethylene naphthalate (PEN) with good transparency having transmittance of a visible ray of 80% or more.

One side of the base sheet 213 including the NIR layer includes an acryl-based adhesive to which (metha)crylic acid monomer 75 to 99.89 weight % having an alkyl group of carbon number 1 to 12, α,β unsturated carboxylic acid monomers 0.1 to 20 weight % (that is, functional monomers) or comprehensive monomer 0.01 to 5 weight % having a hydroxyl group are added. In this case, the functions of the NIR shielding layer can be protected, transparency enabling light to be transmitted smoothly, can be secured, and the base sheet 213 can be easily attached to the other sheet and the front of the panel.

It is preferred that the thickness of the base sheet 213 be set in the range of 50 to 500 μm in order to secure mechanical strength of a range, which the file is rarely damage, and prevent the waste of the manufacturing cost due to unnecessary thickness.

The AR layer 211 may be generally formed using a well-known AR layer. The NIR shielding layer 212 is formed of a material, such as an NIR absorbent having the NIR transmittance of 20% or less in the wavelength band of 800 to 1100 nm, emitted from the PDP. The NIR absorbent may include materials having high optical transmittance of a visible ray region, such as polymethine-base, cyanine-based compound, phthalocyanine-based compound, naphthalocyanine-based compound, buthalocyanine-based compound, anthraquinone-based compound, dithiol-based compound, imonium-based compound, and diimmonium-based compound.

The thickness of the AR layer may be set in the range of 90 to 120 μm, and the thickness of the NIR shielding layer may be set in the range of 100 to 120 μm so that the transmittance of light and the respective functions can be effectively implemented.

The NIR shielding layer 212 formed on the base sheet 213 preferably includes an adhesive layer 230 formed of an adhesive of a pressure sensitive property in order to facilitate the adhesive property with other sheets and the panel. It is preferred that the adhesive include a pressure sensitive adhesive (PSA).

In PDP, in order to correct a lowering in the color purity of a display image by generating a coloring spectrum unique to a specific sealed gas, improve the contrast of a transmitted image, or generate an image having a desired color tone by changing the color tone of the image, the adhesive layer 230 may include coloring agents for color supplement, having the functions of color tone correction and color tone control.

For example, as the coloring agent for color tone, a coloring agent having the maximum absorption characteristic in the wavelength band of 570 to 605 nm may be included in the layer, and the coloring agent for color tone control, having the property of being absorbed in the visible ray range, may be included in the layer. The amount of the coloring agent for color tone or the coloring agent for color tone control may be varied depending on an absorption wavelength and an absorption coefficient or a color tone of the coloring agent, transmittance required at the front of the PDP, and/or the like.

In general, an external light source exists in a room, outside the room or over the head of a user. An external light shielding sheet 220 is attached to the NIR shielding layer 212 in order to represent a black image of the PDP as dark by effectively shielding the external light and to shield EMI radiated from the panel.

Referring to FIG. 14, a filter 300 disposed at the front of the panel may further include an optical characteristic sheet 320 in addition to an AR/NIR sheet 310 and an external light shielding sheet 330, as illustrated in FIGS. 5 and 6. The optical characteristic sheet 320 includes an optical characteristic layer 321 laminated on a base sheet 322. The optical characteristic layer 321 includes a coloring agent for color supplement, having the functions of color tone correction and color tone control. The optical characteristic layer 321 serves to correct lowering in the color purity of the display image, improve the contrast of a transmitted image, and generate an image having a desired color tone by changing the color tone of the image. The optical characteristic layer may include the above PSA-based adhesive in order to facilitate the adhesive property with other sheets.

It is preferred that base sheets 313 and 322 included between the sheets 310 and 320 be formed using substantially the same material and have substantially the same thickness by taking the easiness of fabricating the filter into consideration. Any one of the transparent materials may include robust glass, not a plastic material, in order to improve the function of protecting the panel. In the case where glass is used as the transparent material, it is preferred that the glass be spaced apart from the panel at a specific distance.

Meanwhile, the lamination sequence shown in FIGS. 13 and 14 is only illustrative, and the lamination sequence of the respective sheets may be varied depending on those skilled in the art. Alternatively, any one of the respective sheets may be omitted, and at least one of based sheets respectively included in the respective sheets may be omitted. Furthermore, robust glass not a plastic material may be used in order to improve the function of protecting the panel. In order to enhance the EMI shielding efficiency, an EMI shielding layer that is generally used may be included.

As described above, the plasma display apparatus according to the present invention has been described with reference to the illustrated drawings. However, the present invention is not limited to the embodiments and drawings disclosed in the present specification, but may be applied by those skilled in the art without departing from the scope and spirit of the present invention.

### INDUSTRIAL APPLICABILITY

As described above, according to the plasma display apparatus of the present invention, external light incident on a panel can be shielded, thereby improving the bright and dark room contrast.

In the prior art, a black matrix, an AR layer attached to a filter, and so on have been used in order to improve the bright and dark room contrast of a PDP. In the present invention, however, external light incident on the interior of a discharge cell of the panel can be blocked effectively. Accordingly, it can be expected that the bright and dark contrast of the panel can be improved significantly.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A plasma display apparatus, comprising:
a Plasma Display Panel (PDP);
a transparent substrate spaced apart from and adhered to the PDP;
a base unit formed on the transparent substrate;
pattern units formed within the base unit, wherein a black oxidization process is performed on the pattern units;
an Anti-Reflection (AR) layer formed on the transparent substrate to a thickness of 90 to 120 μm; and
a Near Infrared (NIR) shielding sheet formed on the transparent substrate to a thickness of 100 to 120 μm,
wherein a width at ½ of a height of each of the pattern units is set in the range of 6 to 23 μm, a bottom width of the pattern unit is set in the range of 18 to 35 μm, and the pattern units are formed using a material containing carbon.

2. The plasma display apparatus of claim 1, wherein:
the NIR shielding layer includes an acryl-based adhesive, and
the acryl-based adhesive is a copolymer in which one of (metha)crylic acid monomer 75 to 99.89 weight % having an alkyl group of carbon number 1 to 12, α,β unsturated carboxylic acid monomers 0.1 to 20 weight %, which is functional monomers, and a comprehensive monomer 0.01 to 5 weight % having a hydroxyl group, is mixed of a combination of them are mixed. In this case, the functions of the NIR shielding layer can be protected, transparency enabling light to be transmitted smoothly, can be secured, and the base sheet 213 can be easily attached to the other sheet and the front of the panel.

3. The plasma display apparatus of claim 1, wherein the pattern units are formed using a metal material, such as silver, iron, nickel, chrome, copper, aluminum, titanium or lead.

4. The plasma display apparatus of claim 3, wherein the metal material has a resistance of 0.001 to 2.5Ω.

5. The plasma display apparatus of claim 1, wherein the pattern units include oxide compounds.

6. The plasma display apparatus of claim 5, wherein the oxide compounds include at least one selected from a group comprising copper oxide, copper dioxide and oxidized steel.

7. The plasma display apparatus of claim 1, wherein a refractive index of the pattern unit is 0.300 to 0.999 times greater than that of the base unit.

8. The plasma display apparatus of claim 1, wherein a thickness of the NIR shielding sheet is 1.01 to 2.25 times greater than the height of the pattern unit.

9. The plasma display apparatus of claim 1, wherein the shortest distance between neighboring pattern units is 1.1 to 5 times greater than the bottom width of the pattern unit.

10. The plasma display apparatus of claim 1, wherein the height of the pattern unit is 0.89 to 4.25 times greater than the shortest distance between neighboring pattern units.

11. The plasma display apparatus of claim 1, wherein a distance between tops of neighboring pattern units is 1 to 3.25 times greater than a distance between bottoms of neighboring pattern units.

12. A filter, comprising:
a transparent substrate;
a base unit formed on the transparent substrate;
pattern units formed within the base unit, wherein a black oxidization process is performed on the pattern units;
an Anti-Reflection (AR) layer formed on the transparent substrate to a thickness of 90 to 120 μm; and
a Near Infrared (NIR) shielding sheet formed on the transparent substrate to a thickness of 100 to 120 μm,
wherein a width at ½ of a height of each of the pattern units is set in the range of 6 to 23 μm, a bottom width of the pattern unit is set in the range of 18 to 35 μm, and the pattern units are formed using a material containing carbon.

13. The filter of claim 12, wherein:
the NIR shielding layer includes an acryl-based adhesive, and
the acryl-based adhesive is a copolymer in which one of (metha)crylic acid monomer 75 to 99.89 weight % having an alkyl group of carbon number 1 to 12, α,β unsturated carboxylic acid monomers 0.1 to 20 weight %, which is functional monomers, and a comprehensive monomer 0.01 to 5 weight % having a hydroxyl group, is mixed of a combination of them are mixed. In this case, the functions of the NIR shielding layer can be protected, transparency enabling light to be transmitted smoothly, can be secured, and the base sheet 213 can be easily attached to the other sheet and the front of the panel.

14. The filter of claim 12, wherein the pattern units are formed using a metal material, such as silver, iron, nickel, chrome, copper, aluminum, titanium or lead.

15. The filter of claim 14, wherein the metal material has a resistance of 0.001 to 2.5Ω.

16. The filter of claim 12, wherein the pattern units include oxide compound.

17. The filter of claim 16, wherein the oxide compound includes at least one selected from a group comprising copper oxide, copper dioxide and oxidized steel.

18. The filter of claim 12, wherein a refractive index of the pattern unit is 0.300 to 0.999 times greater than that of the base unit.

19. The filter of claim 12, wherein a thickness of the NIR shielding sheet is 1.01 to 2.25 times greater than the height of the pattern unit.

20. The filter of claim 12, wherein the shortest distance between neighboring pattern units is 1.1 to 5 times greater than the bottom width of the pattern unit.

21. The filter of claim 12, wherein the height of the pattern unit is 0.89 to 4.25 times greater than the shortest distance between neighboring pattern units.

22. The filter of claim 12, wherein a distance between tops of neighboring pattern units is 1 to 3.25 times greater than a distance between bottoms of neighboring pattern units.
